(19) United States
(12) Patent Application Publication
(10) Pub. No.: US 2009/0185880 A1
(43) Pub. Date: Jul. 23, 2009

(54) Universal fastener

(76) Inventors: Yongping Gong, Glenview, IL (US); Mark Latz, Chicago, IL (US); Cheryl L. Panasik, Elburn, IL (US); Michael Dill, Elk Grove, IL (US)

Correspondence Address: Steven W. Weinrieb;LAW OFFICES OF STEVEN W. WEINRIEB, 8717 Cold Spring Road, Potomac, MD, 20854, US

(21) Appl. No.: 12/318,893

(22) Filed: Jan. 12, 2009

Related U.S. Application Data
(60) Provisional application No. 61/006,549, filed on Jan. 18, 2008.

(51) Int. Cl. F16B 25/10

(52) U.S. Cl. 411/387.4

(57) ABSTRACT

A new and improved fastener wherein the tip portion includes a unique and novel structure that enables and facilitates the insertion of the fastener into both wood and concrete substrates. The tip portion includes a half-cone structure in which a pointed tip is defined between a radially outer conical surface portion and a radially inner flat or planar surface portion.

### CROSS-REFERENCE TO RELATED PATENT APPLICATIONS

This patent application is related to, based upon, and effectively a utility patent application conversion of U.S. Provisional Patent Application Ser. No. 61/006,549 which was filed on Jan. 18, 2008, the date-benefits of which are hereby claimed and the entirety of which is incorporated herein by reference to the extent permitted by law.

### FIELD OF THE INVENTION

The present invention relates generally to screws and similar fasteners, and more particularly to a new and improved screw fastener wherein the tip portion comprises a unique and novel structure that enables and facilitates the insertion of the screw fastener into both wood and concrete substrates.

### BACKGROUND OF THE INVENTION

Many different fasteners and other devices are known for securing, for example, brick components to cinder block or concrete structures in order to ensure that the brick components are in fact fixedly secured to the cinder block or concrete structures in addition to the mortar inserted between the brick components and the cinder blocks or concrete structures. One example of such a fastener device is illustrated within FIG. 1 wherein it is seen that a building wall structure, generally designated by the reference character 100, comprises a plurality of cinder blocks or concrete structures 102 which, together effectively define an interior wall structure, and a plurality of brick components 104 which are adapted to be secured as an external veneer structure with respect to the interior wall structure defined by means of the plurality of cinder blocks or concrete structures 102. A space 106 is defined between the plurality of external brick components 104 comprising the external wall structure, and the plurality of interior cinder block or concrete structures 102 comprising the internal wall structure, so as to allow mortar to be placed within the space 106 and between the interior wall structure defined by the plurality of cinder block or concrete structures 102 and the external wall structure defined by the plurality of brick components 104, thereby securing the external wall structure, comprising the plurality of brick components 104, to the interior wall structure comprising the plurality of cinder block or concrete structures. In addition, it is seen that mesh devices 108 are placed atop a layer of the cinder blocks or concrete structures 102 and a layer of the brick components 104 so as to further ensure that the external wall structure, defined by the plurality of brick components 104, is secured to the interior wall structure defined by the plurality of cinder block or concrete structures 102.

Continuing further, and with reference being made to FIG. 2, a second type of fastener, to be used in conjunction with an external wall structure defined by a plurality of brick components 204, for securing the external wall structure to the interior wall structure comprising the plurality of cinder block or concrete structures 202, so as to define an overall wall structure 200, is disclosed and generally indicated by the reference character 210. The fastener 210 is disclosed as comprising a first threaded shank portion 212 which has a conically configured, pointed gimlet tip portion 214, wherein the first shank portion 212 is fabricated from steel. A second non-threaded shank portion 216 and a head member 218, fabricated from zinc, are fixedly attached to the first threaded steel shank portion 212. In turn, an anchor cap 220 is fixedly secured to the head member 218, and it is seen that the anchor cap 220 is provided with a hole 222 so as to receive a tie wire 224. One end of the tie wire 224 is passed through the hole 222 such that a substantially central portion 226 of the tie wire 224 is disposed within the hole 222 defined within the anchor cap 220, while the oppositely disposed end portions 228,230 of the tie wire 224 are disposed atop a layer of brick veneer components 204 in a manner somewhat similar to that of the mesh devices 108 illustrated within FIG. 1 so as to ensure that the external brick veneer wall structure is fixedly secured to the internal cinder block or concrete structure in addition to the mortar, disposed within the space 206 defined between the external brick veneer wall structure and the cinder block or concrete structure 202, which of course also serves to fixedly secure the external brick veneer wall structure to the internal cinder block or concrete structure. While this type of fastener 210 is generally satisfactory, it does have some operational flaws or drawbacks.

For example, the second non-threaded shank portion 216 and head member 218, which are fabricated from zinc, often breaks and separates from the first threaded shank portion 212, which is fabricated from steel, during installation operations. In addition, it is difficult and tedious to insert the fastener into concrete substrates in view of the fact that the full or complete conically configured, pointed gimlet tip portion 214 of the fastener 210 does not provide a large enough or adequate clearance space or path at the forwardmost end portion of the fastener, when a hole 232 is predrilled within the cinder block or concrete 202. Accordingly, debris, dust, and the like, generated from the cinder block or concrete structure 202, during the tapping process when the fastener 210 is rotatably inserted into the cinder block or concrete structure 202, is not able to effectively flow freely or fast enough out from the pre-drilled hole 232, but, to the contrary, tends to effectively accumulate within the pre-drilled hole 232 and thereby substantially increase the insertion torque required to insert the fastener 210 into the cinder block or concrete structure 202. The generation of such substantially increased insertion torque not only results in the insertion process being more tedious and difficult for operator personnel to achieve, but in addition, substantially increases the time it takes to insert the fastener 210 into the cinder block or concrete structure 202. Still further, the conventional fastener 210 is also difficult and tedious when the same is to be inserted into wood substrates. This is because the full or complete circumferential conical tip portion defines an increased amount of surface area which must, of course, engage the wood substrate.

Still yet further, since the fastener 210 is not optimally designed for use within cinder block or concrete substrates, operational field personnel must use different fasteners dependent upon whether or not it is desired to insert a fastener into a particular one of the two different substrates, that is, either a wood substrate or cinder block or concrete substrate. Therefore, this requires the operational field personnel to maintain a supply of multiple fasteners within the field, that is, on the job site, depending upon the particular substrate that a fastener is to be inserted into.

A need therefore exists in the art for a new and improved threaded fastener which can be utilized in both wood and cinder block or concrete substrates.

### SUMMARY OF THE INVENTION

The foregoing and other objectives are achieved in accordance with the teachings and principles of the present invention through the provision of a new and improved fastener which comprises a threaded shank portion, and a first large half-cone structure which comprises a radially inner flat or planar section, a radially outer conical section, and a pointed tip portion, defined upon the forward end of the fastener as a result of the geometrical intersection of the radially inner flat or planar section and the radially outer conical section of the first large half-cone structure, so as to readily, easily, and quickly commence or enable insertion of the fastener into a wood or cinder block or concrete substrate. A second small half-cone structure may be disposed upon and be integral with the radially inner flat or planar section of the first large half-cone structure at a position located axially rearward of the pointed tip portion. Threads are provided upon a forward shank portion of the fastener and terminate immediately upstream of or adjacent to the first large half-cone structure or immediately upstream of or adjacent to the second small half-cone structure when the second small half-cone structure is disposed upon and integral with the inner flat or planar section of the first large half-cone structure.

By providing this new and improved tip portion upon the fastener, comprising only a single first large half-cone structure, or comprising a second small half-cone structure integrally disposed upon the radially inner flat or planar section of the first large half-cone structure, an enlarged clearance space or path is effectively defined upon the forward end portion of the fastener which permits debris, dust, and the like, generated during the threaded insertion or tapping process of the screw fastener into a cinder block or concrete substrate, to be readily and quickly eliminated or discharged. In this manner, the debris, dust, or the like, does not accumulate within the pre-drilled bore formed within the cinder block or concrete substrate, and therefore the insertion torque that needs to be exerted upon the fastener, when the fastener is to be inserted into the cinder block or concrete substrate, is effectively reduced.

Alternatively, when the new and improved fastener is inserted into a wood substrate, the absence of a second large half-cone structure disposed diametrically opposite the first large half-cone structure, or the provision of the second small half-cone structure upon the first large half-cone structure, effectively reduces the amount of surface area of the forward end portion of the fastener that will initially be engaged with the wood substrate so as to likewise facilitate the insertion of the fastener into the wood substrate with less force or torque. Still further, the provision of the pointed tip portion, defined upon the forward end of the fastener as a result of the geometrical intersection of the radially inner flat or planar section and the radially outer conical section of the first large half-cone structure, together with the radially inner flat or planar section of the first large half-cone structure, or together with the second small half-cone structure, permits the fastener to be readily and easily inserted into the concrete or cinder block or wood substrate whereupon the first thread of the fastener, disposed upon the threaded shank portion of the fastener and disposed immediately adjacent to or upstream of the first large half-cone structure, can effectively begin to threadedly engage the concrete or cinder block or wood substrate.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a perspective view of a first conventional system for securing an external brick veneer wall structure, comprising a plurality of brick components, to an internal cinder block wall structure, comprising a plurality of cinder block components, by means of mesh tie members;

FIG. 2 is a top plan view of a second conventional system for securing an external brick veneer wall structure, comprising a plurality of brick components, to an internal cinder block wall structure, comprising a plurality of cinder block components, by means of a screw fastener and tie wire system;

FIG. 3 is a side elevational view of a first embodiment of a new and improved fastener wherein the fastener comprises unique pointed tip structure, as defined by means of a single half-cone structure, which enables the fastener to be readily, easily, and quickly inserted into a wood substrate, and wherein further, the unique pointed tip structure also permits the same fastener to be readily, easily, and quickly inserted into a cinder block or concrete substrate; and

FIG. 4 is a cross-sectional view of the new and improved fastener illustrated within FIG. 3 as taken along the lines 4-4 of FIG. 3;

FIG. 5 is a side elevational view of a second embodiment of a new and improved fastener, which is similar to the first embodiment of the new and improved fastener as illustrated within FIG. 3, wherein, again, the fastener comprises unique pointed tip structure, as defined by means of a first large half-cone structure and a second small half-cone structure integrally disposed upon a radially inner flat or planar portion of the first large half-cone structure, which enables the fastener to be readily, easily, and quickly inserted into a wood substrate, and wherein further, the unique pointed tip structure also permits the same fastener to be readily, easily, and quickly inserted into a cinder block or concrete substrate; and

FIG. 6 is a cross-sectional view of the new and improved fastener illustrated within FIG. 5 as taken along the lines 6-6 of FIG. 5.

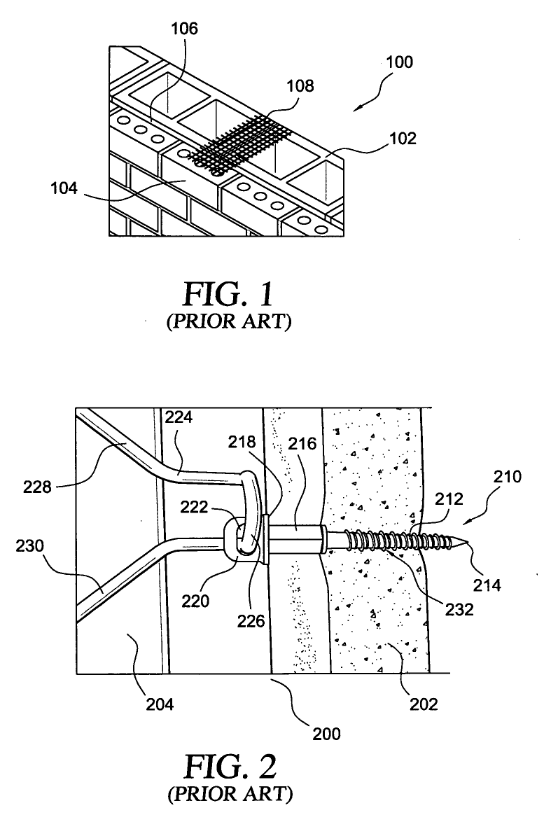

### DETAILED DESCRIPTION OF THE PREFERRED EMBODIMENT

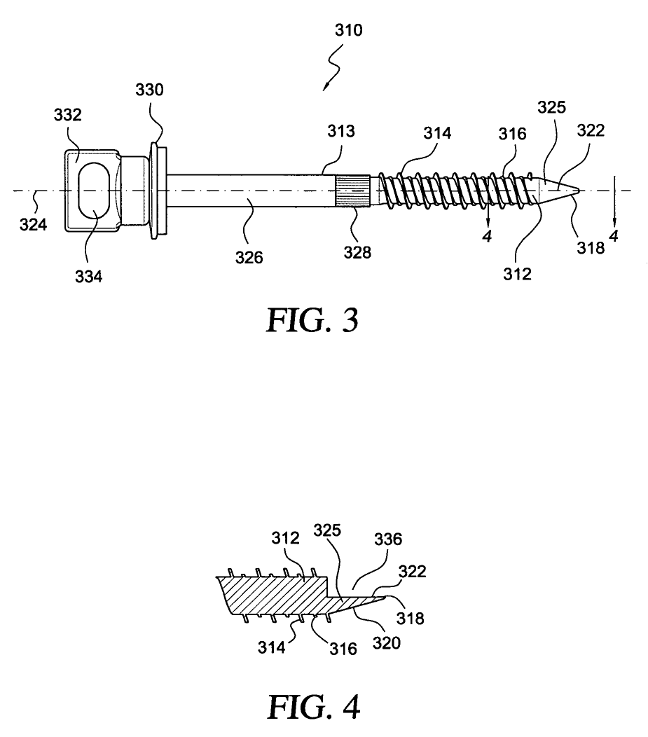

Referring now to the drawings, and more particularly to FIGS. 3 and 4 thereof, there is disclosed a first embodiment of a new and improved fastener which is adapted to be inserted into a wood substrate, and is likewise adapted to be inserted into a cinder block or concrete substrate so as to, for example, effectively secure an external wall structure, defined by means of a plurality of brick components, to an interior wall structure comprising a plurality of cinder block or concrete components, wherein the new and improved fastener is generally indicated by the reference character 310. The new and improved fastener 310 is somewhat similar to the conventional fastener as disclosed within FIG. 2, and therefore structural components of the first embodiment of the new and improved fastener 310 consistent with the present invention, which correspond to similar structural components of the conventional fastener 210, as illustrated within FIG. 2, will be designated by corresponding reference characters except that the reference characters will be within the 300 series. More particularly, it is firstly noted that all components or parts of the first embodiment of the new and improved fastener 310 are fabricated from steel, and that the fastener 310 comprises a first forward threaded shank portion 312 which extends forwardly from a substantially axially central portion of a shank member 313 and which has a plurality of first high or primary threads 314 disposed thereon and a plurality of second low or secondary threads 316 disposed thereon, wherein the second low secondary threads are interposed between successive ones of the first high primary threads.

In addition, and in accordance with the principles and teachings consistent with the present invention, the fastener 310 is provided with a pointed tip portion 318 which is effectively formed as a result of the geometrical intersection of a radially outer conical surface portion 320, and a radially inner flat or planar portion 32 which is coplanar with the longitudinal axis 324 of the fastener 310, the radially outer conical surface portion 320 and the radially inner flat or planar portion 322 together defining a single half-cone structure 325. It is also seen that the fastener 310 comprises a second non-threaded shank portion 326 disposed upstream or rearwardly of the first threaded portion 312 of the fastener and which extends rearwardly from a substantially central portion of the shank member 313 toward the end of the fastener disposed opposite the pointed tip portion 318, and that the external diameter of the second non-threaded shank portion 326 is slightly larger than the external diameter of the first shank portion 312 as considered at the root portions of the threads defined upon the first shank portion 312. A reamer section 328 is provided upon the forward or downstream end portion of the second non-threaded shank portion 326 for reaming out a hole formed either, for example, within insulation or wall board which may be fixedly attached to the interior wall structure comprising the plurality of cinder block or concrete components, or when the fastener 310 is installed within a wood substrate.

Still further, it is seen that the fastener also comprises a head member 330, and an anchor cap 332 which is fixedly secured to the head member 330 by any suitable means, such as, for example, a swaging process. As was the case with the conventional anchor cap 220 illustrated within FIG. 2, the anchor cap 332 is provided with a hole 334 so as to receive a tie wire, not shown, in a manner previously described in connection with tie wire 224. That is, one end of the tie wire is passed through the hole 334 such that a substantially central portion of the tie wire is disposed within the hole 334 defined within the anchor cap 332, while the oppositely disposed end portions of the tie wire are disposed atop a layer of brick veneer components in a manner somewhat similar to that discussed in connection with the tie wire 224 of the conventional system illustrated within FIG. 2 so as to ensure that the external brick veneer wall structure is fixedly secured to the internal cinder block or concrete wall structure in addition to the mortar disposed within the space defined between the external brick veneer wall structure and the internal cinder block or concrete wall structure.

By providing the uniquely configured pointed tip portion 318 of the new and improved fastener 310, as can best be seen from FIG. 4, it can be appreciated that the single half-cone structure 325 also effectively defines a half conically configured open space 336 which, in turn, defines a relatively large clearance passage-way or path which, in fact, will permit debris, dust, and the like, generated during the threaded insertion or tapping process of the screw fastener 310 into a cinder block or concrete substrate, to be readily and quickly eliminated or discharged so that such debris, dust, or the like, does not accumulate within the predrilled bore formed within the cinder block or concrete substrate. In this manner, there is no accumulation of debris, dust, or the like to effectively impede the insertion of the fastener 310 into the cinder block or concrete substrates whereby the amount of force or torque that must be exerted upon the fastener 310 in order to insert the same into the cinder block or concrete substrates is substantially reduced due to the defined flow or escape of such debris, dust, or the like through the open space 336 that defines the escape passageway or path. Under such circumstances, it can also be appreciated that the installation time for inserting the fastener 310 into the cinder block or concrete substrate is also substantially reduced. In a similar manner, when the fastener 310 is to be inserted into a wood substrate, by providing the uniquely configured pointed tip portion 318 of the new and improved fastener 310, as can best be seen from FIG. 4, the single half-cone structure 325 permits the pointed tip portion 318 to be readily and easily inserted into the wood comprising the wood substrate, however, the utilization of the single half-cone structure 325 comprises only substantially half of the amount of fastener point material comprising a conventional or conventional pointed tip fastener which must initially engage the wood forming the wood substrate, such as, for example, the conventional fastener 210 illustrated within FIG. 2, which can therefore be appreciated does not work well within wood substrates. Accordingly, the amount of force or torque that must be exerted upon the fastener 310 in order to insert the same into a wood substrate is substantially reduced as is the installation time required to insert the fastener 310 into the wood substrate. Once the single half-cone structure 325 is inserted into the wood substrate, the first thread disposed upon the threaded shank portion 312 of the fastener 310 can then begin to threadedly engage the wood forming the wood substrate.

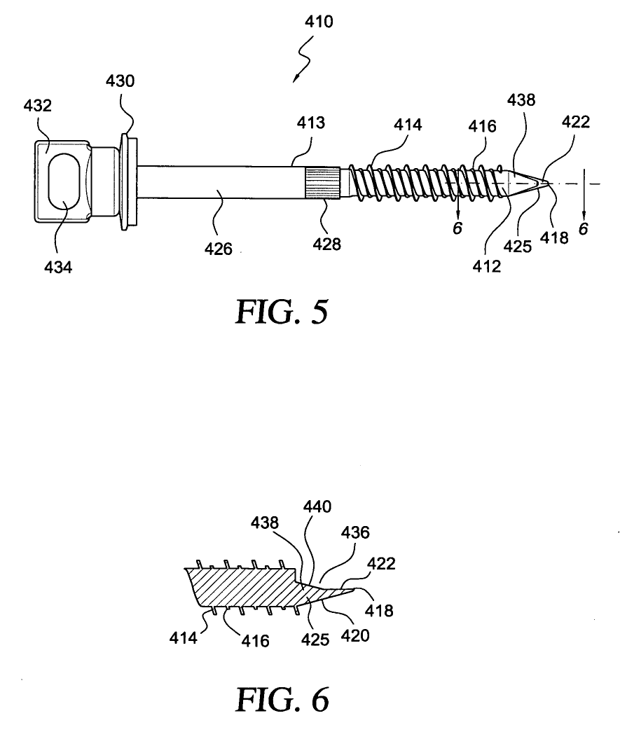

With reference lastly being made to FIGS. 5 and 6, a second embodiment of a new and improved fastener, which is adapted to be inserted into a wood substrate, and is likewise adapted to be inserted into a cinder block or concrete substrate so as to, for example, effectively secure an external wall structure, defined by means of a plurality of brick components, to an interior wall structure comprising a plurality of cinder block or concrete components, is illustrated and generally indicated by the reference character 410. The new and improved fastener 410 is similar to the fastener as disclosed within FIGS. 3 and 4, except as will be noted shortly hereinafter, and therefore structural components of the second embodiment of the new and improved fastener 410, which correspond to similar structural components of the first embodiment fastener 310, as illustrated within FIGS. 3 and 4, will be designated by corresponding reference characters except that the reference characters will be within the 400 series. It is to be appreciated that the only significant difference between the second embodiment fastener 410 consistent with the present invention, as compared to the first embodiment fastener 310 consistent with the present invention, resides in the fact that in lieu of the half conically configured open space 336, a second relatively smaller half-cone structure 438 is disposed upon and integral with the radially inner flat or planar surface portion 422 of the first relatively larger half-cone structure 425.

The second relatively smaller half-cone structure 438 is provided with an external half-conical surface 440 as can best be seen in FIG. 6. The provision of the second relatively smaller half-cone structure 438 adds some strength and rigidity to the first relatively larger half-cone structure 425, however, a substantial space 436, similar to, but admittedly somewhat smaller than the space 336, is nevertheless defined and maintained so as to still permit the debris, dust, or the like, generated during the tapping of the fastener 410 into a cinder block or concrete substrate to nevertheless flow freely and escape, and therefore not accumulate so as to impede the insertion of the fastener 410 into the predrilled hole of the cinder block or concrete substrate. In a similar manner, when the fastener 410 is to be inserted into a wooden substrate, there is admittedly somewhat more material disposed upon the forward end of the fastener 410 to engage the wood material as a result of the presence of the second relatively smaller half-cone structure 438, however, the amount of additional material of the fastener 410 is not significant enough to impede the relatively easy and quick insertion of the fastener 410 into the wood substrate. More particularly, as can be appreciated from FIG. 6, the second relatively smaller half-cone structure 438 is effectively smoothly integrated with or into the first relatively larger half cone structure 425 so as to in fact permit the forward end portion of the fastener 410 to nevertheless be readily, easily, and quickly inserted into the wood substrate.

Thus, it may be seen that in accordance with the teachings and principles consistent with the present invention, there has been provided a new and improved fastener wherein the tip portion comprises a unique and novel structure that enables and facilitates the insertion of the screw fastener into both wood and concrete substrates.

Obviously, many variations and modifications of the present invention are possible in light of the above teachings. It is therefore to be understood that within the scope of the appended claims, the present invention may be practiced otherwise than as specifically described herein.

What is claimed is:

1. A fastener comprising:
a shank member defined around a longitudinal axis;
a head member disposed upon a first end of said shank member; and
a pointed tip portion defined upon a second end of said shank member opposite said first end of said shank member,
wherein said pointed tip portion comprises a half-cone structure defined by a radially outer conical surface portion and a radially inner planar portion coplanar with said longitudinal axis such that a pointed tip is defined by the intersection of said radially outer conical surface portion and said radially inner planar portion, wherein further, an open space is defined adjacent to a surface portion of said radially inner planar portion, such that said open space and surface portion are effective to allow any debris, generated during the insertion of said fastener into a substrate, to flow freely through said open space defining said clearance pathway so as not to impede the insertion of said fastener into a substrate, and wherein still further, the definition of said open space effectively defines less material upon said fastener to be engaged with said substrate so as to effectively permit insertion of said fastener into the substrate.

2. The fastener as set forth in claim 1, further comprising:
an anchor cap fixedly secured to said head member of said fastener; and
a hole defined within said anchor cap for passage therethrough of a tie wire.

3. The fastener as set forth in claim 1, wherein:
said shank member has a threaded forward section extending from a substantially axially central portion of said shank member toward said pointed tip portion of said fastener, and a non-threaded rearward section extending from a substantially axially central portion of said shank member toward said head member.

4. The fastener as set forth in claim 3, further comprising:
a reamer portion interposed between said threaded forward section of said shank member and said non-threaded rearward section of said shank member.

5. The fastener as set forth in claim 3, wherein:
said threaded forward section of said fastener comprises a plurality of first high primary threads, and a plurality of second low secondary threads interposed between successive ones of said first high primary threads.

6. The fastener as set forth in claim 3, wherein:
the external diameter of said non-threaded rearward section of said shank member is slightly larger than the external diameter of said threaded forward section of said shank member as considered at the root portions of said threads defined upon said first shank portion.

7. The fastener as set forth in claim 1, wherein:
the substrate is concrete.

8. The fastener as set forth in claim 1, wherein:
the substrate is wood.

9. A fastener comprising:
a shank member defined around a longitudinal axis;
a head member disposed upon a first end of said shank member; and
a pointed tip portion defined upon a second end of said shank member opposite said first end of said shank member,
wherein said pointed tip portion comprises a first relatively large half-cone structure defined by a radially outer conical surface portion and a radially inner planar portion coplanar with said longitudinal axis such that a pointed tip is defined by the intersection of said radially outer conical surface portion and said radially inner planar portion;
a second relatively smaller half-cone structure is integrally disposed upon said radially inner planar portion of said first relatively large half-cone structure whereby an open space is defined adjacent to a surface portion of said radially inner planar portion such that said open space and surface portion are effective to allow any debris, generated during the insertion of said fastener into a substrate, to flow freely through said open space defining said clearance pathway so as not to impede the insertion of said fastener into a substrate, and wherein still further, the definition of said open space effectively defines less material upon said fastener to be engaged with the substrate so as to effectively permit insertion of said fastener into the substrate.

10. The fastener as set forth in claim 9, further comprising:
an anchor cap fixedly secured to said head member of said fastener; and
a hole defined within said anchor cap for passage therethrough of a tie wire.

11. The fastener as set forth in claim 9, wherein:
said shank member has a threaded forward section extending from a substantially axially central portion of said shank member toward said pointed tip portion of said fastener, and a non-threaded rearward section extending from a substantially axially central portion of said shank member toward said head member.

12. The fastener as set forth in claim 11, further comprising:
a reamer portion interposed between said threaded forward section of said shank member and said non-threaded rearward section of said shank member.

13. The fastener as set forth in claim 11, wherein:
said threaded forward section of said fastener comprises a plurality of first high primary threads, and a plurality of second low secondary threads interposed between successive ones of said first high primary threads.

14. The fastener as set forth in claim 11, wherein:
the external diameter of said non-threaded rearward section of said shank member is slightly larger than the external diameter of said threaded forward section of said shank member as considered at the root portions of said threads defined upon said first shank portion.

15. The fastener as set forth in claim 9 wherein:
the substrate is concrete.

16. The fastener as set forth in claim 9 wherein:
the substrate is wood.
